(19) United States
(12) Patent Application Publication
(10) Pub. No.: US 2011/0087647 A1
(43) Pub. Date: Apr. 14, 2011

(54) SYSTEM AND METHOD FOR PROVIDING WEB SEARCH RESULTS TO A PARTICULAR COMPUTER USER BASED ON THE POPULARITY OF THE SEARCH RESULTS WITH OTHER COMPUTER USERS

(76) Inventors: Alessio Signorini, Boulder, CO (US); Ioannls Pavlids, Boulder, CO (US); Nathaniel Fisher, Boulder, CO (US); Scott Engstrom, Longmont, CO (US); Peter J. Newcomb, Erie, CO (US); David L. Young, Boulder, CO (US); Ron Benson, Boulder, CO (US)

(21) Appl. No.: 12/578,421

(22) Filed: Oct. 13, 2009

(51) Int. Cl. G06F 17/30

(52) U.S. Cl. 707/709; 707/755; 707/711; 707/E17.083; 707/E17.061; 707/E17.108; 707/E17.115

(57) ABSTRACT

A system and method for providing Web search results to a particular computer user based on the popularity of the search results with other computer users is described. One embodiment monitors, using one or more servers, at least one Web service for new actions of sharing of Web content by computer users; identifies, from the new actions of sharing of Web content by computer users, a data item that satisfies predetermined interestingness criteria; parses the data item to obtain at least one Uniform Resource Locator (URL); crawls at least one Web page corresponding to the at least one URL to obtain the content of the at least one Web page; analyzes the content of the at least one Web page; and updates an index based on the content of the at least one Web page, the index being usable in processing a Web search query from a particular user.

### RELATED APPLICATIONS

The present application is related to the following commonly owned and assigned U.S. patent applications: application Ser. No. 12/098,772, Attorney Docket No. MEDM-001/03US, “System and Method for Dynamically Generating and Managing an Online Context-Driven Interactive Social Network”; and application Ser. No. 12/491,104, Attorney Docket No. MEDM-003/01US, “Method and System for Ranking Web Pages in a Search Engine Based on Direct Evidence of Interest to End Users”; each of which is incorporated herein by reference in its entirety.

### FIELD OF THE INVENTION

The present invention relates generally to World Wide Web (Web) search engines. In particular, but not by way of limitation, the present invention relates to methods and systems for providing Web search results to a particular computer user based on the popularity of the search results with other computer users.

### BACKGROUND OF THE INVENTION

Over the past decade or so, some form of Internet access has become available to almost everyone in industrialized countries. More recently, there has been an exponential growth in on-line social activities. People do not use the Internet just for e-mail or news anymore. Rather, they want to communicate with one another to exchange photos; political and religious ideas; recipes; suggestions for books, music, and movies; news; videos; and other information. There is a major “social component” to today's Internet.

This desire for on-line social interaction has given rise to thousands of social networks on the Web. Some of the better known social networks are FACEBOOK, which permits users to communicate by text and exchange pictures and other information; TWITTER, which permits users to submit short updates (microblog entries) regarding their daily lives and activities; MYSPACE, which permits users to create personal profiles with their favorite movies, music, etc.; and DIGG, which permits users to submit and vote on Web pages that they believe are interesting.

One thing common to all of these various social networking services is that users can “share” (post or exchange), with other users in a social network, Uniform Resource Locators (URLs) or “links” pointing to Web content they find interesting. For example, a user might post a link to a video or photo the user finds interesting on his or her “wall” on FACEBOOK. Similarly, a user might include a link to a particular Web page he or she finds interesting in a “tweet” (a microblog entry on TWITTER). Millions of links (news, videos, photos, articles, etc.) are shared by users in this way each day via social networking Web sites.

Although conventional search engines like GOGGLE attempt to make Web content searchable and accessible, such search engines have some weaknesses. First, such conventional search engines generally rank search results (Web pages) based on the extent to which they are linked to by other Web pages. Unfortunately, this is not always a reliable indication of popularity among end users. Second, conventional search engines do not take into account the sharing of URLs among users in on-line social networks. Third, conventional search engines do not effectively keep up with what is “hot” among users in real-time, as reflected in their sharing behavior in social networking services like those mentioned above.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a system and method for providing World Wide Web (Web) search results to a particular computer user based on the popularity of the search results with other computer users. One illustrative embodiment is a computer-implemented method for providing Web search results to a particular computer user based on the popularity of the search results with other computer users, comprising monitoring, using one or more servers, at least one Web service for new actions of sharing of Web content by computer users; identifying, from the new actions of sharing of Web content by computer users, a data item that satisfies predetermined interestingness criteria; parsing the data item to obtain at least one Uniform Resource Locator (URL); crawling at least one Web page corresponding to the at least one URL to obtain the content of the at least one Web page; analyzing the content of the at least one Web page; and updating an index based on the content of the at least one Web page, the index being usable in processing a Web search query from the particular user.

Another illustrative embodiment is a system for providing Web search results to a particular computer user based on the popularity of the search results with other computer users, comprising one or more computer storage devices; one or more monitor servers configured to monitor at least one Web service for new actions of sharing of Web content by computer users; and identify, from the new actions of sharing of Web content by computer users, a data item that satisfies predetermined interestingness criteria; a content parser configured to parse the data item to obtain at least one Uniform Resource Locator (URL); and an indexing server configured to crawl at least one Web page corresponding to the at least one URL to obtain the content of the at least one Web page; analyze the content of the at least one Web page; and update an index based on the content of the at least one Web page, the index residing on the one or more computer storage devices, the index being usable in processing a Web search query from the particular user.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying drawings, wherein:

FIG. 1 is a high-level functional block diagram of a system for monitoring Web services for new actions of sharing of Web content by computer users in accordance with an illustrative embodiment of the invention;

FIG. 2A is a high-level functional block diagram of a system for providing Web search results to a particular computer user based on the popularity of the search results with other computer users in accordance with an illustrative embodiment of the invention;

FIG. 2B is a functional block diagram of a server configuration by which the system shown in FIG. 2A can be implemented in accordance with an illustrative embodiment of the invention;

FIG. 3 is a functional block diagram of an ingest portion of the system shown in FIG. 2A in accordance with an illustrative embodiment of the invention;

FIG. 4 is a functional block diagram of a real-time server of the system shown in FIG. 2A in accordance with an illustrative embodiment of the invention;

FIG. 5 is a functional block diagram of an indexing server of the system shown in FIG. 2A in accordance with an illustrative embodiment of the invention;

FIG. 6 is a functional block diagram of a search server of the system shown in FIG. 2A in accordance with an illustrative embodiment of the invention;

FIG. 7 is a flowchart of a method for providing Web search results to a particular computer user based on the popularity of the search results with other computer users in accordance with an illustrative embodiment of the invention; and

FIG. 8 is a flowchart of a method for providing Web search results to a particular computer user based on the popularity of the search results with other computer users in accordance with another illustrative embodiment of the invention.

### DETAILED DESCRIPTION

In various illustrative embodiments of the invention, one or more monitor servers are used to monitor one or more Web services in real time for new actions of sharing of Web content by computer users. For example, a monitor server might detect that a user has just shared Web content with other users by submitting a “tweet” on TWITTER that includes a Uniform Resource Locator (URL) or “link” pointing to Web content (e.g., a photo, a video, an article, etc.) the user finds interesting. Among the monitored new actions of content sharing, data items are identified that satisfy predetermined criteria of interestingness. Such data items are then parsed to obtain the URLs embedded within them.

Web pages corresponding to those URLs are then “crawled” (accessed) to obtain the content of those Web pages. The content of the Web pages is analyzed (e.g., classified and dechromed), and a Web search index is updated based on the analyzed content of the Web pages. That Web search index can then be used to provide ranked search results to a particular computer user based on the popularity of the search results to other computer users, as determined from the monitored sharing behavior.

The overall approach just summarized has at least a couple of important advantages. First, since the monitoring of sharing activities and updating of the search index is carried out in real time, it permits a search engine to provide more immediate, timely results to the user than those returned by conventional search engines. Second, since the content is indexed based, at least in part, on users' sharing behavior on Web services such as social networks, the search results tend to be more relevant to the user submitting the search query because they are ranked in accordance with their popularity with other computer users. That is, the search results returned are potentially of greater interest to the user than those returned by a conventional search engine such as GOOGLE, BING, or YAHOO. In short, the inventive approach indexes Web content in a new way based on users' actions of sharing Web content with one another on-line, those actions of sharing serving as an indication of the actual popularity of the content with users.

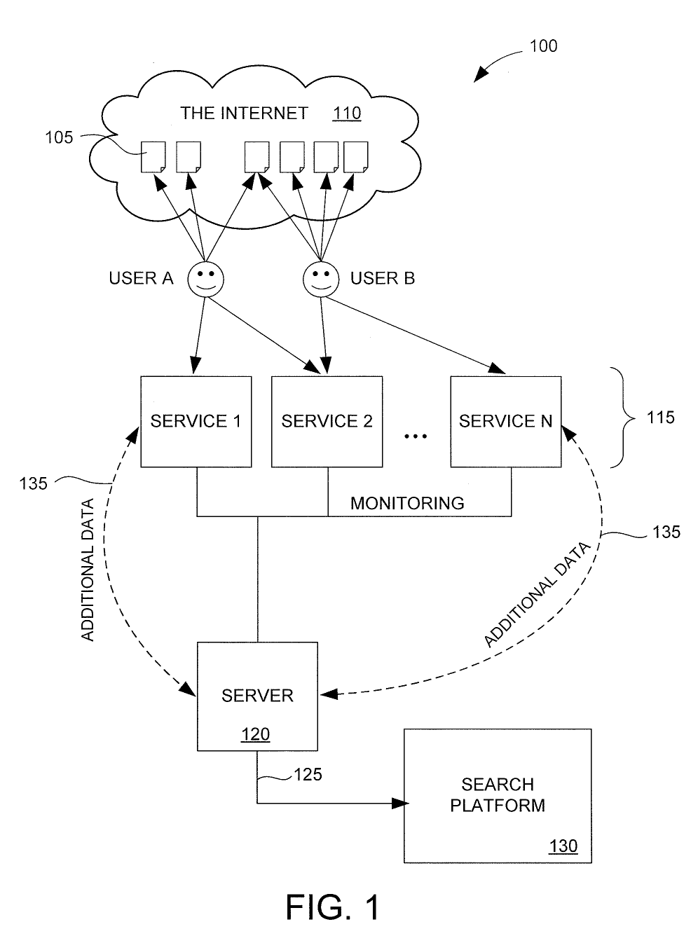

Referring now to the drawings, where like or similar elements are designated with identical reference numerals throughout the several views, and referring in particular to FIG. 1, it is a high-level functional block diagram of a system 100 for monitoring Web services 115 for new actions of sharing of Web content by computer users in accordance with an illustrative embodiment of the invention. FIG. 1 focuses primarily on what herein will be referred to as the “ingest” (monitoring and screening) portion of a larger Web search platform to be described more fully below.

In FIG. 1, Users A and B access various World-Wide-Web (Web) pages 105 over the Internet 110. The depiction of two users in FIG. 1 rather than some other number is merely illustrative and has no particular significance. As explained above, Users A and B can share URLs corresponding to Web content of interest with other users via one or more Web services 115. Web services 115 may include social networking sites such as FACEBOOK or MYSPACE; sharing services such as DIGG, blogging services such as BLOGGER, micro-blogging services such as TWITTER, individual syndicated-content feeds, aggregated syndicated-content feeds, and Web services that collect clickstream data reported by an application running on a computer user's client computer.

One or more servers 120 monitor new actions of sharing Web content by Users A and B. Data items associated with the new actions of sharing Web content are parsed to obtain one or more URLs, and URLs that are deemed “interesting” are identified based on predetermined criteria. Those URLs that are deemed “interesting” are then forwarded to a Web search platform 130 for crawling and indexing. The resulting index is usable in responding to user search queries submitted to Web search platform 130.

In some embodiments, the server 120 may acquire additional data 135 from Web services 115 or from parsing the data items themselves. The additional data 135 may include, without limitation, information on the user who shared the URL (e.g., a username or a thumbnail picture); information on the user who created the content corresponding to the shared URL; information on the system used to share the URL; information on the action of sharing the URL; or information regarding Web pages that users visited prior to interacting with a URL they later shared, the time those users spent on those other Web sites, or other pertinent details.

“Sharing” of Web content by users, as used herein, can be divided into two basic categories. In a first category called “explicit sharing,” a user intentionally submits, to a Web service 115 (e.g., a social networking site), a URL pointing to Web content. For example, a user might post a URL (link) pointing to a news article in a blog entry on blogspot.com, or the user might submit a “tweet” (microblog entry) on TWITTER that includes a URL that points to a video on YOUTUBE. Other examples of explicit sharing include, without limitation, posting a URL on a social networking site (e.g., the user's “wall” on FACEBOOK), posting a comment about a URL on a Web service 115, and submitting a vote regarding a URL on a sharing service such as DIGG.

In a second category called “implicit sharing,” the user is not consciously aware, moment to moment, that he or she is “sharing” Web content with anyone else. Rather, the user has agreed beforehand to accept installation of an application on his or her client computer that automatically reports the user's clickstream behavior (URLs visited) in real time to a Web service 115. Examples, without limitation, of such a client application are the toolbar applications produced by OneRiot and Alexa. Such a Web service 115 that collects clickstream data automatically reported by users' client machines can be among the Web services 115 monitored by server 120.

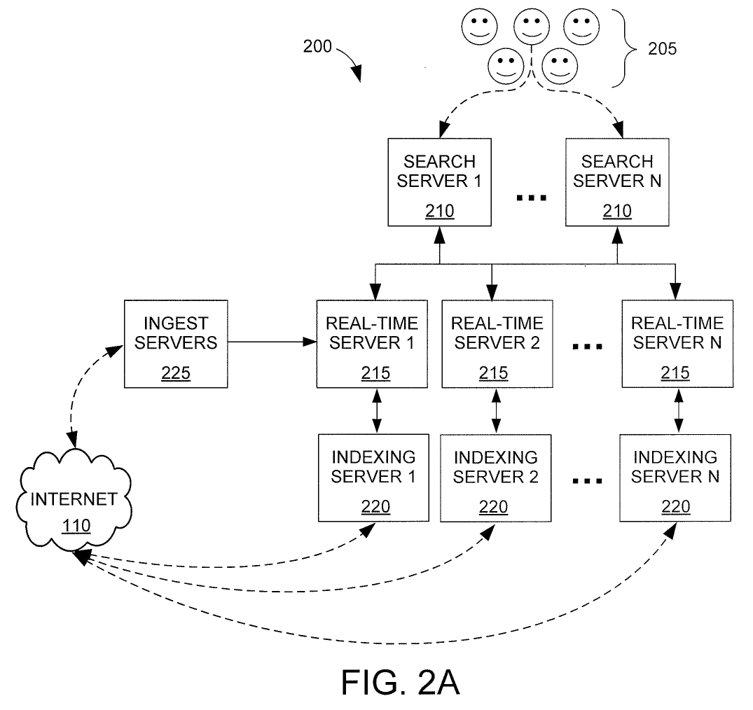

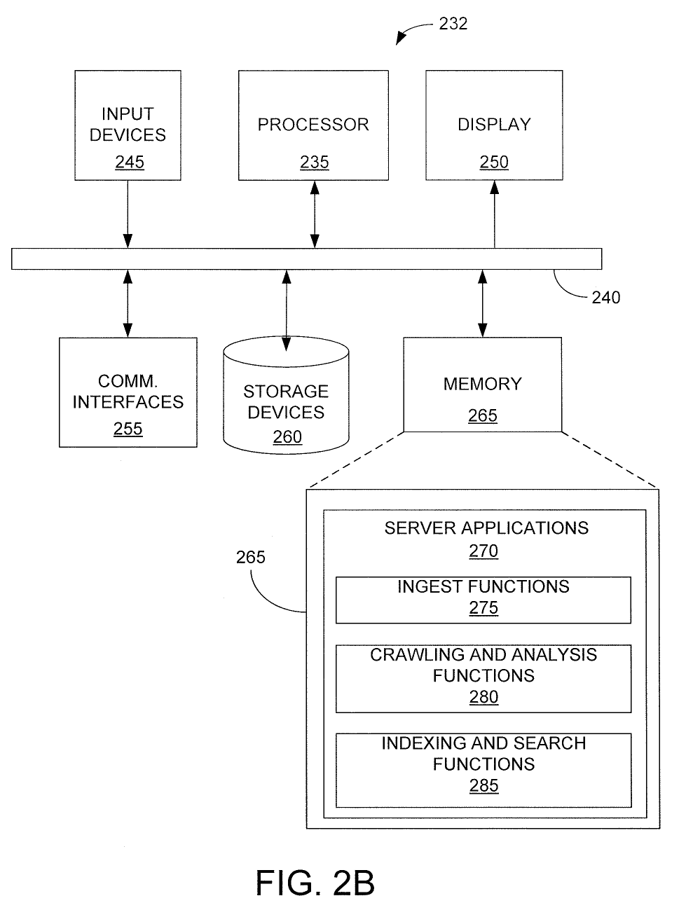

Referring next to FIG. 2A, it is a high-level functional block diagram of a system 200 for providing Web search results to a particular computer user based on the popularity of the search results with other computer users in accordance with an illustrative embodiment of the invention. In this illustrative embodiment, users 205 submit search queries to one or more search servers 210, which forward the queries to one or more real-time servers 215. For a given query, each real-time server 215 consults its own internally stored index for relevant URLs, optionally supplements each URL with correlated additional information (to be explained more fully below), and sends the URLs and any correlated additional information to the search servers 210. Search servers 210 collect the URLs from all of the real-time servers involved in responding to the query, rank them according to their social impact (e.g., popularity), and present the top N to the user, where N may vary from embodiment to embodiment. Optionally, the URLs included in the search results can be supplemented with some or all of the correlated additional information about those URLs.

In parallel with the search operations just described, one or more ingest servers 225 monitor Web services 115 (see FIG. 1) in real time for new actions of sharing of Web content that have “interesting” associated data items, as explained above in connection with FIG. 1. Each URL found in an “interesting” data item, together with optional correlated additional information obtained by parsing the data item in which it was found or by accessing external network resources, is sent to real-time servers 215. If the URL is new (not previously encountered), a real-time server 215 sends the URL to its associated indexing server 220 for crawling and indexing. Once the content associated with the URL has been crawled, analyzed, and indexed, associated information based on the content analysis such as the content's category or language is sent back to the real-time server 215 for storage and use in subsequent searches.

In carrying out these functions, ingest servers 225, indexing servers 220, and search servers 210 communicate with other computers (servers or users' client machines) via the Internet 110.

The various components and features of system 200 are described in further detail in connection with FIGS. 2B through 6 below.

FIG. 2B is a functional block diagram of a server configuration 232 by which the system shown in FIG. 2A can be implemented in accordance with an illustrative embodiment of the invention. Server configuration 232 may be a single physical machine in some embodiments or, in other embodiments, it may be several different distributed computers, with their associated software, that are networked together to implement the functionality of system 200.

In FIG. 2B, processor 235 communicates over data bus 240 with input devices 245, display 250, communication interfaces (“COMM. INTERFACES” in FIG. 2B) 255, storage devices 260 (e.g., hard disk drives or flash memory), and memory 265. Though FIG. 2B shows only a single processor, multiple processors or a multi-core processor may be present in some embodiments. Again, in some embodiments, there may be a plurality of different physical machines involved, each with its own processor, memory, communication interfaces, and other components.

Input devices 245 may include, for example, a keyboard, a mouse or other pointing device, or other devices that are used to input data or commands to server configuration 232 to control its operation. Communication interfaces 255 may include, for example, various serial or parallel interfaces for communicating with other servers or client machines via Internet 110 or with one or more locally connected or networked peripherals.

Memory 265 may include, without limitation, random access memory (RAM), read-only memory (ROM), flash memory, magnetic storage (e.g., a hard disk drive), optical storage, or a combination of these, depending on the particular embodiment. As with processor 235, memory 265 may, in some embodiments, be a plurality of different memories residing on different physical machines.

In FIG. 2B, memory 265 includes a set of server applications 270. In one illustrative embodiment, these server applications may be broadly categorized as ingest functions 275, crawling and analysis functions 280, and indexing and search functions 285. These functions correspond to the various functional blocks of system 200 shown in FIG. 2A. The manner of subdividing and labeling the functionality of system 200 shown in FIG. 2B is merely one way of doing so and is not intended to be limiting. The functional units of system 200 may be subdivided, combined, or labeled in other ways in other embodiments. In one illustrative embodiment, the server applications 270 are implemented as software that is executed by processor 235. Such software may be stored, prior to its being loaded into RAM for execution by processor 235, on any suitable computer-readable storage medium such as a hard disk drive, an optical disk, or a flash memory (see storage devices 260 in FIG. 2B). The specific functions performed by ingest functions 275, crawling and analysis functions 280, and indexing and search functions 285 will become apparent as various parts of system 200 are described in greater detail below.

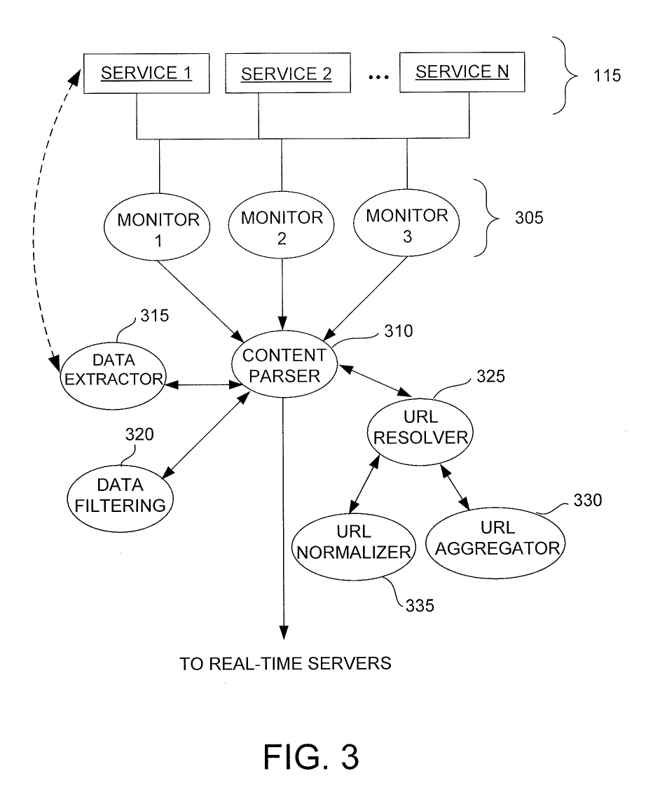

FIG. 3 is a functional block diagram of an ingest portion of system 200 shown in FIG. 2A in accordance with an illustrative embodiment of the invention. The functional unit labeled “Ingest Servers 225” in FIG. 2A includes several different components, including monitor servers 305, content parser 310, data extractor 315, data filter 320, URL resolver 325, URL aggregator 330, and URL normalizer 335. The functionality of each of these components will be briefly described.

Monitor servers 305 monitor Web services 115 in real time for new actions of sharing of Web content by computer users, as discussed above in connection with FIG. 1. Though three monitor servers 305 are depicted in FIG. 3, there may be more or fewer monitor servers, depending on the particular embodiment.

Monitor servers 305 examine the new actions of sharing of Web content to identify interesting data items. The predetermined criteria for what constitutes an “interesting” data item can vary, depending on the particular embodiment. In one embodiment, a data item that contains a URL is considered “interesting.” For example, in such an embodiment, a URL shared on a social-networking site such as FACEBOOK or a tweet on TWITTER that contains a URL is considered “interesting.” In another embodiment, an indication of popularity among computer users regarding a URL contained within a data item makes that data item “interesting.” One example, without limitation, of such indications of popularity are that one or more computer users voted, on a sharing service like DIGG, for the URL contained within the data item. Another example is that the URL contained within the data item is among the most-accessed URLs on a particular Web service 115 (e.g., the most-viewed videos on YOUTUBE). In general, the criteria for what constitutes an “interesting” data item may be flexibly defined depending on the requirements of the particular embodiment.

Data items may be deemed “not interesting” for a variety of reasons. Some of those reasons could include, without limitation, that the data item was generated by an automated system, that the data item duplicates other sharing activities, that the data item represents a clear attempt to manipulate the system, that the data item contains or points to inappropriate content (e.g., pornography), or that the sharing activity or the data contained within it is out of date.

The manner in which monitor servers 305 access Web services 115 in real time varies, depending on the particular embodiment. In one embodiment, monitor servers 305 user a public application programming interface (API) to access a Web service 115. For example, YOUTUBE provides a public API that enables monitor servers 305 to monitor newly uploaded content as it arrives. This API also provides comments, if any, about specific videos and how many users have viewed them. The owners of many other sites, including FRIENDFEED, provide similar public APIs.

Some social networking Web sites are more open than others. For example, TWITTER is a mostly open environment (users can access other users' tweets without having an account on the site), though individual users can choose to keep their tweets private. FACEBOOK, on the other hand, is a mostly closed environment. Access to such closed Web services 115 can, in some cases, be obtained by special arrangement with the operators of the Web service 115. In summary, monitor servers 305 use special URLs (APIs) provided by the owners of the monitored Web services 115 to access those services. The API may be public, in some embodiments, or it may be obtained by special arrangement with the owner of the particular Web service 115.

In some embodiments, monitor servers 305 poll Web services 115 frequently (e.g., every 5-10 seconds) to check for new actions of sharing of Web content by users. In other embodiments, new actions of sharing of Web content by users are “pushed” to monitor servers 305 as they occur by prior special arrangement with the owner of the applicable Web service 115. In still other embodiments, a combination of polling and pushing are used. For example, polling might be used with some Web services 115 and pushing with others.

The interesting data items that monitor servers 305 identify are sent to content parser 310, which parses each interesting data item to obtain at least one URL. In some embodiments, content parser 310 obtains additional information about the URLs contained in an “interesting” data item (see discussion above of additional information 135 in connection with FIG. 1). In those embodiments, content parser 310 obtains additional information about the URLs contained in a data item by parsing the data item, consulting external resources on the network, or both. Where external network resources need to be consulted, content parser 310 can use data extractor 315 to communicate with external resources on the Internet 110 such as the originating Web service 115.

URL resolver 325 resolves the final network destination to which a URL corresponds and ensures that the URL exists. URL normalizer 335 generates a standard canonical form for the URL (e.g., by removing empty parameters such as “www”). URL aggregator 330 identifies variations in a URL that are equivalent to the canonical form of the URL. For example, redundant URLs that point to the same ultimate network destination as the canonical form can be mapped to or otherwise associated with the canonical form.

In some embodiments, data filter 320 is configured to filter out spam or adult content (e.g., pornography). Data filter 320 can also be configured to classify interesting data items, the URLs contained within interesting data items, or both, depending on the particular embodiment. Where the URLs are classified, the domain of each URL, the username of the user who shared the URL, or a combination of these can also be part of the classification.

Once content parser 310 has collected all of the relevant data (URLs and correlated additional data such as additional data 135), it aggregates the data and submits a final data package to the real-time servers 215 (see FIG. 2A).

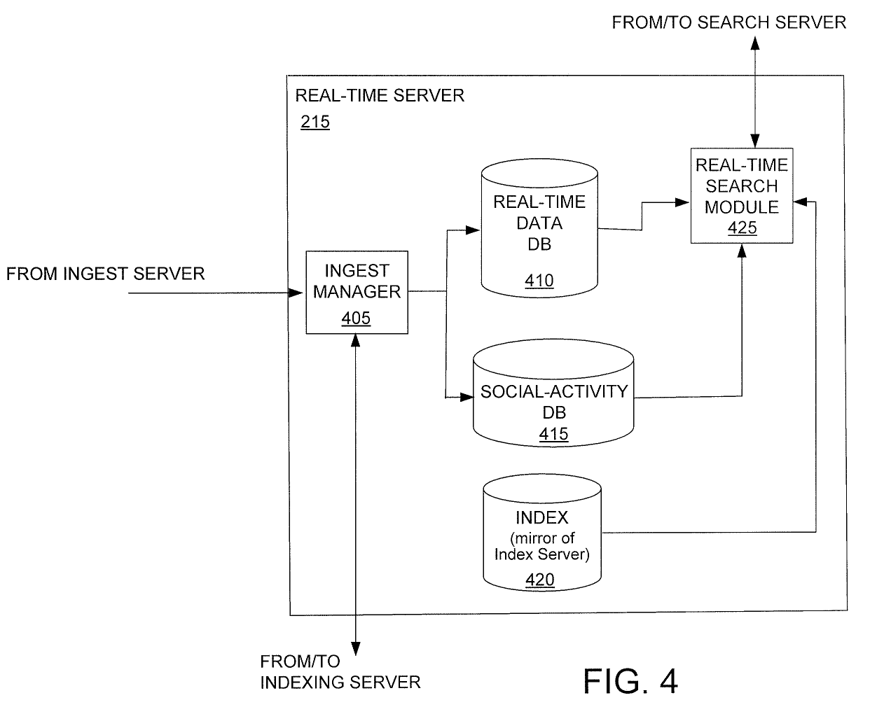

FIG. 4 is a functional block diagram of a real-time server 215 in accordance with an illustrative embodiment of the invention. In the embodiment shown in FIG. 4, real-time server 215 includes ingest manager 405, real-time-data database (DB) 410, social-activity DB 415, index 420 (a mirror of the index used by indexing servers 220), and real-time search module 425.

Ingest manager 405 receives URLs obtained from interesting data items by the ingest servers 225, as explained above. In this illustrative embodiment, ingest manager 405 keeps track, in real-time-data DB 410, of various information about the URL. If the URL has been encountered previously, ingest manager 405 updates such information about the URL. The information updated can include, without limitation, comments in a list of comments about the URL, a list of short URLs corresponding to the URL, a count of the number of times the URL has been shared or voted for, and a last-shared timestamp. If the appropriate data have been updated and the URL is fairly recent (e.g., less than 24 hours since it was last crawled), no further processing is necessary.

If an interesting URL is new (i.e., has not been encountered before) or has not been crawled for a predetermined period (e.g., more than 24 hours), ingest manager 405, after creating an entry in real-time-data DB 410 and populating it with the kind of data described above in connection with previously-encountered URLs, sends it to its associated indexing server 220 for crawling, parsing and analysis, and indexing. The processes of crawling, parsing and analysis, and indexing are explained more fully below.

Ingest manager 405 also saves, in social-activity DB 415, the text of the data item that contained the shared URL, if available, and information about the user who shared the URL such as the user's name, username, location, or image.

Real-time search module 425 receives search queries from search servers 210, as explained above, and looks for relevant URLs in its own index 420, which is a mirror of the master copy maintained by the corresponding indexing server 220. In one embodiment, a “relevant” URL is one for which the relevance score of the corresponding content (calculated using standard information-retrieval techniques) exceeds a predetermined threshold. Real-time search module 425 optionally supplements the relevant URLs with additional information stored in real-time-data DB 410, social-activity DB 415, or both. Real-time search module 425 sends the relevant URLs or supplemented relevant URLs back to search servers 210 for ranking and presentation to the user who submitted the search query.

At any given time, real-time server 215 and its associated indexing server 220 maintain up to three similar copies of the text index: (1) a “live” index, (2) a non-optimized index, and (3) an optimized search index. The “live index” is maintained by the indexing server 220 associated with a given real-time server 215. Indexing server 220 updates this “live index” constantly as it crawls Web content. At predefined intervals (e.g., once each minute), a non-optimized copy of the index is sent from indexing server 220 to its associated real-time server 215. Real-time server 215 performs a clean up and optimization process on this non-optimized version of the index to remove deleted documents and to improve performance. Once cleaned up and optimized, this third copy of the index is used as the search index (index 420) to respond to search queries received from search servers 210.

In some embodiments, the index 420 of real-time server 215 is implemented as two separate text indexes, a small one that resides completely within RAM or other high-speed memory and a second, larger one that is stored on a mass storage device such as a hard disk drive. Once real-time server 215 has received a non-optimized copy of the text index from indexing server 220 and has optimized it, the text index on disk is replaced by the newly optimized version, and part of it (e.g., the most recent one to three days' worth of data) replaces the smaller in-memory index. Some search queries implicate only the in-memory index, whereas other queries can also involve use of the on-disk index, if insufficient data is found in the small in-memory index.

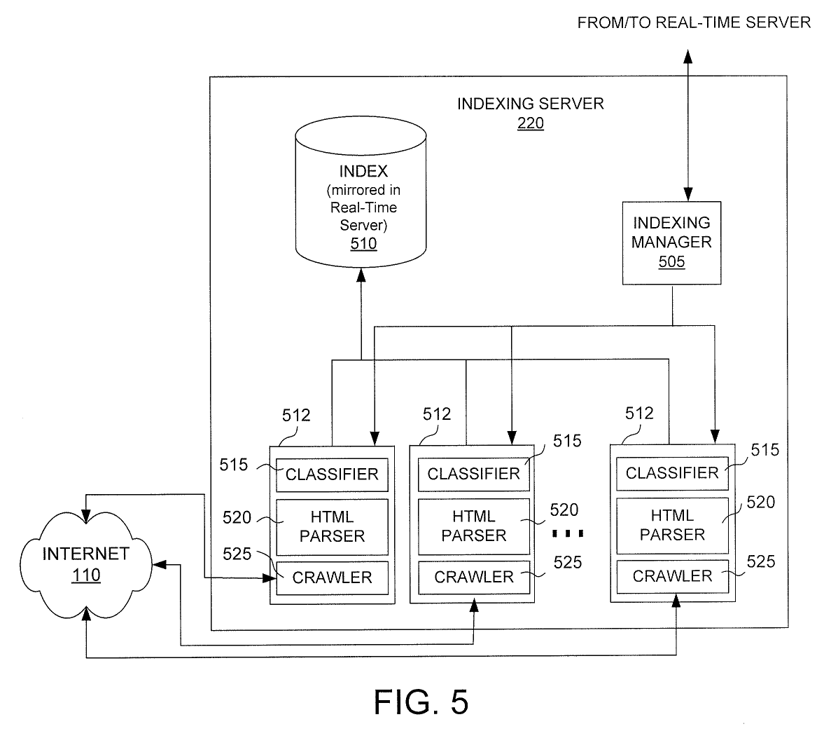

Referring next to FIG. 5, it is a functional block diagram of an indexing server 220 in accordance with an illustrative embodiment of the invention. As noted above, indexing server 220 receives URLs to crawl, parse, analyze, and index from the ingest manager 405 of its associated real-time server 215. Each URL received is sent to an available crawler unit 512, which fetches the content pointed to by the URL from the Internet 110 (crawler 525), parses it (HTML parser 520), and analyzes and classifies it (classifier 515). (Note: “HTML” stands for “Hyper Text Markup Language.”) In some embodiments, indexing server 220 includes a plurality of crawler units 512.

Crawler 525 is capable of downloading multiple pages in parallel. Once a URL has been crawled by crawler 525 to obtain the corresponding content, an HTML parser 520 and a classifier 515 of indexing server 220 proceed to parse and analyze the content. The operations performed during this analysis phase include, but are not limited to, the following:

Media Identification: The objective here is to understand what the relevant media—image, video, and sound files—are on a Web page and to correlate them with the corresponding URL.

Language Classification: Using well-known artificial-intelligence methods (e.g., SVN or Bayesian Classification), the content of the Web page is analyzed to determine the language (e.g., English, Spanish) in which the page is written.

Adult Classification: Again, using well-known artificial-intelligence methods (e.g., SVN or Bayesian Classification), the content of the Web page is analyzed to determine whether it is intended for an adult audience.

Category Classification: Again, using well-known artificial-intelligence methods (e.g., SVN or Bayesian Classification), the content of the Web page is analyzed to ascertain its type (e.g., blog, news, image, video) and topical category (e.g., sports, politics, entertainment).

Spam Removal: Again, using well-known artificial-intelligence methods (e.g., SVN or Bayesian Classification), the content of the Web page is analyzed to determine whether it is, or contains, spam (mass solicitation).

Dechroming: Utilizing heuristics on the HTML document object model (DOM), HTML parser 520 extracts all paragraphs from the Web page. Paragraphs that do not appear to be regular text (e.g., a menu containing many links) are discarded in some embodiments. In some embodiments, dechroming includes maintaining a running log of the paragraphs extracted from the Web pages of each particular domain. Paragraphs whose frequency of occurrence is deemed too high, based on predetermined frequency-of-occurrence criteria, are automatically discarded as irrelevant. Such redundancy can occur with, for example, menus or banners that are common to all or most of the Web pages on a given Web site. Further, the association between certain HTML tags (e.g., those for links, italics, and boldface type) and the portion of the text to which they pertain is maintained for later use in indexing.

Once indexing server 220 has analyzed the content, it proceeds to index the relevant text contained in the page using standard indexing technologies (e.g., inverted index). That is, crawler unit 512 sends the information obtained through crawling, parsing, content analysis, and content classification to the local index 510 for indexing and storage, and part of that information is also sent back to the associated real-time server 215 for storage in the real-time-data DB 410 or social-activity DB 415.

It should be noted that, during text indexing, in addition to the standard information (e.g., word frequency) typically stored by conventional indexing technologies, each word can be associated with additional metadata such as word position or the presence of certain HTML tags surrounding the word. Such information can be used during ranking to boost the relevance of that word in the document.

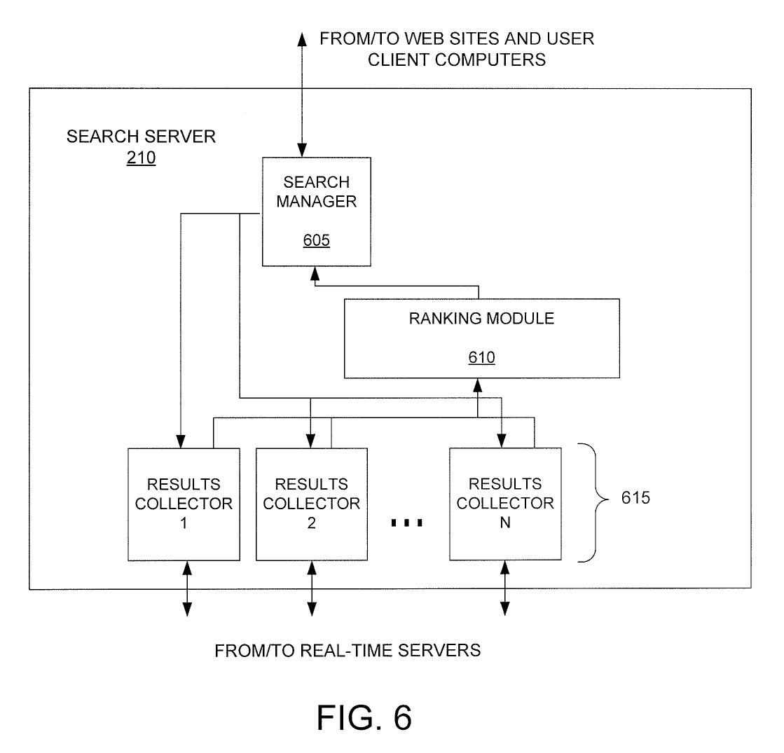

FIG. 6 is a functional block diagram of a search server 210 in accordance with an illustrative embodiment of the invention. In this particular embodiment, search server 210 includes search manager 605, ranking module 610, and one or more results collectors 615. Search manager 605 receives search queries from users' client computers over the Internet 110 and forwards the queries to one or more real-time servers 215, as explained above. To target the query to a specific real-time server 215, search manager 605 sends the query to a particular results collector 615 that is associated with that real-time server 215. Results collector 615 handles the communication and collects the results that are returned by the real-time server 215.

Once the results collector 615 has received the results (URLs and additional related information) for a given query, it forwards them to ranking module 610, which sorts the results in accordance with predetermined ranking criteria (e.g., freshness or “hotness”) and sends the top N results to the requesting user's client machine.

Ranking module 610 may employ any of a variety of ranking algorithms, depending on the particular embodiment. The ranking algorithm can take advantage of the statistical and/or social information associated with a URL that is returned as part of the search results by real-time server 215. In one embodiment, the search results are sorted in order of decreasing “freshness,” which can be defined as how recently each URL was last shared by a computer user (e.g., the date and time the URL was last shared). In another embodiment, social and/or statistical information (e.g., who shared the URL, acceleration in popularity of the URL, domain authority, etc.) is combined with “freshness” to rank the search results.

The search results that search server 210 returns to the user can include the ranked URLs themselves, the content (text, images, etc.) corresponding to the ranked URLs or a portion thereof (e.g., an excerpt taken from the content), additional information that is correlated with the ranked URLs, or a combination of these. In addition to the additional data 135 discussed above that is obtained during the ingest phase, the additional information correlated with a URL among the ranked search-result URLs can include, without limitation, statistical data such as an indication of how many times computer users have shared the URL, an indication of how many comments have been submitted by computer users regarding the URL, or how many times computer users have voted for the URL on a sharing site.

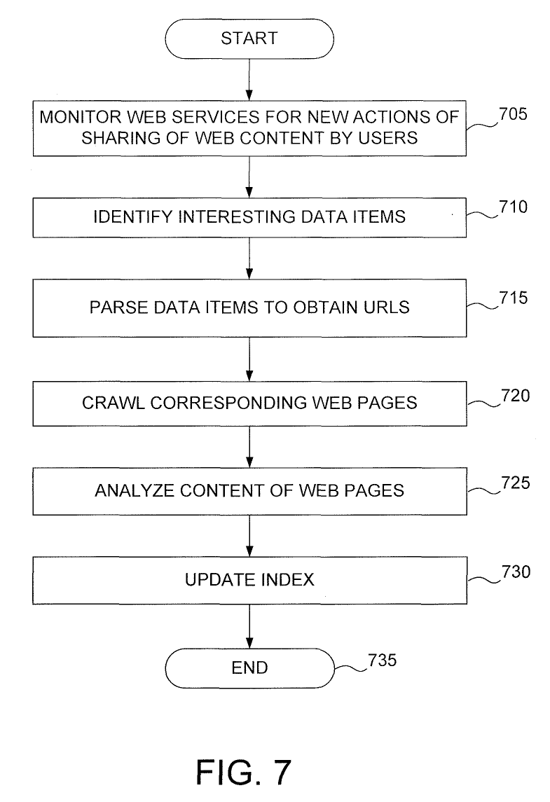

Referring next to FIG. 7, it is a flowchart of a method for providing Web search results to a particular computer user based on the popularity of the search results with other computer users in accordance with an illustrative embodiment of the invention. At 705, monitor servers 305 monitor one or more Web services 115 for new actions of sharing of Web content by computer users. As discussed above, such sharing may be explicit or implicit. As also mentioned above, this monitoring is performed in real time in some embodiments. At 710, monitor servers 305 identify, from the new actions of sharing of Web content by the computer users, an interesting data item that satisfies predetermined interestingness criteria, as discussed above.

At 715, content parser 310 parses the data item to obtain at least one URL and, optionally, other related information. At 720, a crawler 525 of an indexing server 220 crawls one or more Web pages corresponding to the URL to obtain the content of the Web pages. At 725, a HTML parser 520 and a classifier 515 of the indexing server 220 analyze the content of the Web pages, as explained above. At 730, indexing server 220 and real-time server 215 update the text index (see elements 420 and 510). The text index is usable in processing a Web search query from a requesting computer user. At 735, the process terminates.

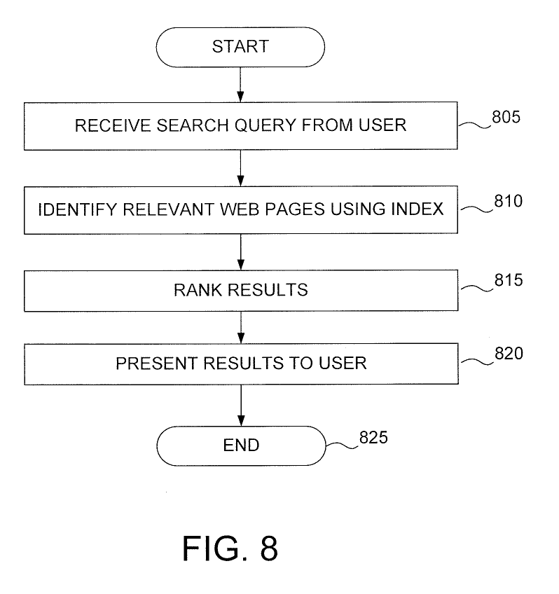

FIG. 8 is a flowchart of a method for providing Web search results to a particular computer user based on the popularity of the search results with other computer users in accordance with another illustrative embodiment of the invention. FIG. 8 illustrates the processing of a search query by system 200. At 805, a search server 210 receives a Web search query from a particular computer user. As discussed above, search server 210, at 810, forwards the query to a real-time server 215, which uses its index 420 to identify relevant URLs. Real-time server 215 returns those URLs, along with additional correlated information such as additional data 135 and statistical (sharing and/or voting) and classification data, to the search server 210. At 815, ranking module 610 of search server 210 ranks the returned URLs and, at 820, presents the ranked URLs to the user as search results. At 825, the process terminates.

In conclusion, the present invention provides, among other things, a system and method for providing Web search results to a particular computer user based on the popularity of the search results with other computer users. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A computer-implemented method for providing World Wide Web (“Web”) search results to a particular computer user based on the popularity of the search results with other computer users, the method comprising:
monitoring, using one or more servers, at least one Web service for new actions of sharing of Web content by computer users;
identifying, from the new actions of sharing of Web content by computer users, a data item that satisfies predetermined interestingness criteria;
parsing the data item to obtain at least one Uniform Resource Locator (URL);
crawling at least one Web page corresponding to the at least one URL to obtain the content of the at least one Web page;
analyzing the content of the at least one Web page; and
updating an index based on the content of the at least one Web page, the index being usable in processing a Web search query from the particular user.

2. The computer-implemented method of claim 1, further comprising:
receiving, at a search server hosting a Web search engine, a search query from the particular computer user;
identifying, using the index, one or more URLs that are relevant to the search query;
ranking the one or more URLs that are relevant to the search query to produce a set of ranked URLs; and
presenting the set of ranked URLs to the particular computer user as search results.

3. The computer-implemented method of claim 2, wherein the search results are supplemented with additional information about the URLs in the set of ranked URLs.

4. The computer-implemented method of claim 3, wherein the additional information about a URL in the set of ranked URLs is obtained through at least one of the parsing of the data item in which the URL in the set of ranked URLs was found and analyzing content corresponding to the URL in the set of ranked URLs.

5. The computer-implemented method of claim 3, wherein the additional information about the URL in the set of ranked URLs includes at least one an indication of how many times computer users have shared the URL in the set of ranked URLs, an indication of how many comments have been submitted by computer users regarding the URL in the set of ranked URLs, an indication of how many times computer users have voted for the URL in the set of ranked URLs, a thumbnail picture associated with a user who shared the URL in the set of ranked URLs, a media file associated with the URL in the set of ranked URLs, information about a computer user who shared the URL in the set of ranked URLs, information about a computer user who created content corresponding to the URL in the set of ranked URLs, information about a system used to share the URL in the set of ranked URLs, information about a sharing action involving the URL in the set of ranked URLs, information about Web pages visited by one or more computer users prior to interaction by those computer users with the URL in the set of ranked URLs, and at least a portion of the content corresponding to the URL in the set of ranked URLs.

6. The computer-implemented method of claim 2, wherein the identified one or more URLs that are relevant to the search query are ranked, at least in part, in accordance with how recently they were last shared by a computer user.

7. The computer-implemented method of claim 2, wherein the identified one or more URLs that are relevant to the search query are ranked, at least in part, in accordance with at least one of social and statistical information associated with the one or more URLs that are relevant to the search query.

8. The computer-implemented method of claim 1, wherein the at least one Web service is monitored in real time.

9. The computer-implemented method of claim 1, wherein the at least one Web service is monitored via a public application programming interface (API) of the at least one Web service.

10. The computer-implemented method of claim 1, wherein the new actions of sharing of Web content by computer users include actions of implicit sharing.

11. The computer-implemented method of claim 10, wherein an action of implicit sharing includes a computer user accessing a URL, the accessing of the URL being reported to a Web service by an application running on the computer user's client computer.

12. The computer-implemented method of claim 1, wherein the new actions of sharing of Web content by computer users include actions of explicit sharing.

13. The computer-implemented method of claim 12, wherein an action of explicit sharing includes one of posting a URL on a social networking service, posting a URL on a blogging service, posting a URL on a micro-blogging service, posting a comment about a URL on a Web service, and submitting a vote regarding a URL on a sharing service.

14. The computer-implemented method of claim 1, wherein the at least one Web service includes at least one social networking service.

15. The computer-implemented method of claim 1, wherein the at least one Web service includes at least one of a social networking service, a sharing service, a blogging service, a micro-blogging service, an individual syndicated-content feed, an aggregated syndicated-content feed, and a Web service that collects clickstream data reported by an application running on computer users' client machines.

16. The computer-implemented method of claim 1, wherein the predetermined interestingness criteria include at least one of that the data item include one or more URLs and that a URL within the data item receive a predetermined indication of popularity among computer users.

17. The computer-implemented method of claim 16, wherein the predetermined indication of popularity among computer users is that one or more computer users voted, on a sharing service, for a URL within the data item.

18. The computer-implemented method of claim 16, wherein the predetermined indication of popularity among computer users is that a URL within the data item is identified by a Web service as being among a set of most-accessed URLs on that Web service.

19. The computer-implemented method of claim 1, wherein the analyzing includes at least one of media identification, language classification, adult-content classification, category classification, spam removal, and dechroming.

20. The computer-implemented method of claim 19, wherein dechroming includes:
maintaining a running log of content extracted from Web pages in a particular domain; and
discarding as irrelevant one or more portions of the content extracted from the Web pages in the particular domain based on their frequency of occurrence.

21. A system for providing World Wide Web (“Web”) search results to a particular computer user based on the popularity of the search results with other computer users, the system comprising:
one or more computer storage devices;
one or more monitor servers configured to:
monitor at least one Web service for new actions of sharing of Web content by computer users; and
identify, from the new actions of sharing of Web content by computer users, a data item that satisfies predetermined interestingness criteria;
a content parser configured to parse the data item to obtain at least one Uniform Resource Locator (URL); and
an indexing server configured to:
crawl at least one Web page corresponding to the at least one URL to obtain the content of the at least one Web page;
analyze the content of the at least one Web page; and
update an index based on the content of the at least one Web page, the index residing on the one or more computer storage devices, the index being usable in processing a Web search query from the particular user.

22. The system of claim 21, further comprising:
a search server configured to receive a search query from the particular computer user; and
a real-time server configured to identify, using the index, one or more URLs that are relevant to the search query;
wherein the search server is configured to rank the one or more URLs that are relevant to the search query to produce a set of ranked URLs and to present the set of ranked URLs to the particular computer user as search results.

23. The system of claim 21, further comprising:
a data extractor in communication with the content parser, the data extractor being configured to communicate with the at least one Web service to obtain additional information about at least one of the data item and the at least one URL.

24. The system of claim 21, further comprising:
a data filter in communication with the content parser, the data filter being configured to classify at least one of the data item and the at least one URL.

25. The system of claim 21, further comprising:
a URL resolver in communication with the content parser, the URL resolver being configured to resolve a final network destination corresponding to the at least one URL;
a URL normalizer in communication with the URL resolver, the URL normalizer being configured to generate a canonical form of the at least one URL; and
a URL aggregator in communication with the URL resolver, the URL aggregator being configured to identify variations of the at least one URL that are equivalent to the canonical form of the at least one URL.

26. The system of claim 21, wherein the system is distributed among a plurality of computers.

27. A system for providing World Wide Web (“Web”) search results to a particular computer user based on the popularity of the search results with other computer users, the system comprising:
at least one processor;
at least one communication interface; and
a memory containing a plurality of program instructions configured to cause the at least one processor to:
monitor, via the at least one communication interface, at least one Web service for new actions of sharing of Web content by computer users;
identify, from the new actions of sharing of Web content by computer users, a data item that satisfies predetermined interestingness criteria;
parse the data item to obtain at least one Uniform Resource Locator (URL);
crawl, via the at least one communication interface, at least one Web page corresponding to the at least one URL to obtain the content of the at least one Web page;
analyze the content of the at least one Web page; and
update an index based on the content of the at least one Web page, the index being usable in processing a Web search query from the particular user.

28. The system of claim 27, wherein the plurality of program instructions are configured to cause the at least one processor to:
receive, via the at least one communication interface, a search query from the particular computer user;
identify, using the index, one or more URLs that are relevant to the search query;
rank the one or more URLs to produce a set of ranked URLs; and
present, via the at least one communication interface, the set of ranked URLs to the particular computer user as search results.
